(19) United States
(12) Patent Application Publication
(10) Pub. No.: US 2020/0310838 A1
(43) Pub. Date: Oct. 1, 2020

(54) ENHANCED USABILITY FOR PRODUCT ENHANCEMENT SUBMISSIONS

(71) Applicant: LENOVO ENTERPRISE SOLUTIONS (SINGAPORE) PTE. LTD., SINGAPORE (SG)

(72) Inventors: JEFFERY J. VAN HEUKLON, ROCHESTER, MN (US); CHEKIM CHHOUR, SHANGHAI (CN); RYAN P. RANDOLPH, ROCHESTER, MN (US)

(21) Appl. No.: 16/370,369

(22) Filed: Mar. 29, 2019

(51) Int. Cl. G06F 9/451; G06F 16/9032; G06F 16/9035; G06F 3/0484

(52) U.S. Cl. CPC G06F 9/451; G06F 3/04842; G06F 16/9035; G06F 16/90324

(57) ABSTRACT

Enhanced usability for product enhancement submissions may include identifying, in response to an indication to generate a product enhancement submission associated with a first user interface, one or more data values within the first user interface; replacing, in the first user interface, the one or more data values with one or more substitute values; generating an image of the first user interface comprising the one or more substitute values; and providing a second user interface facilitating generating the product enhancement submission, wherein the second user interface comprises the image of the first user interface

### BACKGROUND

### Field of the Invention

The field of the invention is data processing, or, more specifically, methods, apparatus, and products for enhanced usability for product enhancement submissions.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Product developers may receive feedback from users regarding ways to enhance their product. Solely text-based feedback mechanisms require a user to describe the proposed enhancement, which may lead to confusion when interpreting the description. Screenshots of the product may be used to assist in describing the product. However, these screenshots may include sensitive information that the user may not wish to divulge to the developer.

### SUMMARY

Enhanced usability for product enhancement submissions may include identifying, in response to an indication to generate a product enhancement submission associated with a first user interface, one or more data values within the first user interface; replacing, in the first user interface, the one or more data values with one or more substitute values; generating an image of the first user interface comprising the one or more substitute values; and providing a second user interface facilitating generating the product enhancement submission, wherein the second user interface comprises the image of the first user interface.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is an example system for enhanced usability for product enhancement submissions.

FIG. 2 is a block diagram of a computing system for enhanced usability for product enhancement submissions.

FIG. 3 is an example user interface for enhanced usability for product enhancement submissions.

FIG. 4 is an example user interface for enhanced usability for product enhancement submissions.

FIG. 5 is an example user interface for enhanced usability for product enhancement submissions.

FIG. 6 is a flowchart of an example method for enhanced usability for product enhancement submissions.

FIG. 7 is a flowchart of an example method for enhanced usability for product enhancement submissions.

FIG. 8 is a flowchart of an example method for enhanced usability for product enhancement submissions.

### DETAILED DESCRIPTION

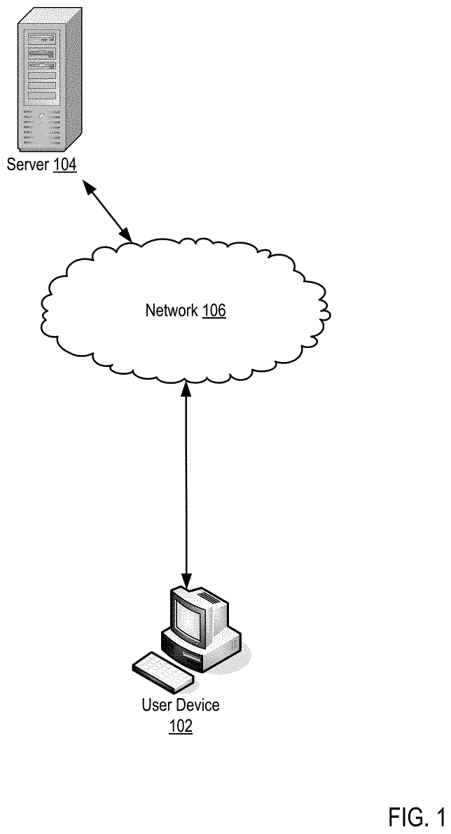

Exemplary methods, apparatus, and products for enhanced usability for product enhancement submissions in accordance with the present invention are described with reference to the accompanying drawings, beginning with FIG. 1. FIG. 1 sets forth a network diagram of a system configured for enhanced usability for product enhancement submissions according to embodiments of the present invention. The system of FIG. 1 includes a user device 102 and server 104 which are in communication via a network 106. The user device 102 may comprise a laptop computer, desktop computer, mobile device (e.g., smartphone or tablet), or other computing device as can be appreciated. The server 104 may comprise one or more servers 104 configured to provide content and/or services (e.g., web sites, web content, web applications) to the user device 102. The network 106 may comprise one or more Local Area Networks (LANs), Wide Area Networks (WANs), cellular networks, personal area networks, wired or wireless networks, or combinations thereof.

The server 104 may be configured to provide a web-based service (e.g., a product) to the user device 102. The product may comprise functionality facilitated by one or more web sites or other network content. The product may include a feature soliciting product enhancement submissions from users. Such product enhancements can include desired features to be added, desired changes or modifications, bug reports, etc. A user may begin submitting a product enhancement submission by selecting a button, link, or other user interface element associated with the product. For example, the user interface element may be included in a template, header, or menu of the product such that it is accessible across multiple pages, screens, or user interfaces of the product. In other words, a selection of the user interface element may cause an indication to the server 104 that a product enhancement submission is to be generated for the user interface (e.g., a first user interface) currently being accessed (e.g., viewed or rendered) by the user device 102.

In response to the indication to generate the product enhancement submission associated with the first user interface, the server 104 may identify one or more data values within the first user interface. The one or more data values may comprise one or more data values that a user may wish to obfuscate or conceal from a third party (e.g., a product developer, another user, etc.). For example, the one or more data values may include a user ID, contact information including a real name, address, phone number, or email address, network identifiers including Internet Protocol (IP) addresses, Media Access Control (MAC) addresses, hardware or device configuration information, etc.

Identifying the one or more data values within the first user interface may comprise identifying, from a plurality of data fields within the first user interface, one or more data fields comprising an identifier. The plurality of data fields may comprise input fields for a user to input a particular data value. The plurality of data fields may also comprise fields for displaying data values communicated by the server 104. For example, the user interface may be encoded using a markup language or other layout encoding that allows for tags, codes, or other identifiers to be associated with data fields. Accordingly, identifying the one or more data fields comprising the identifier may comprise identifying, from the plurality of data fields, the one or more data fields associated with a tag, code, or identifier indicating that a corresponding data value should be obfuscated in the product enhancement submission. Thus, the one or more data values may be identified as the one or more data values corresponding to the identified one or more data fields

Identifying the one or more data values within the first user interface may also comprise identifying each data field or data value within a particular template element or user interface element (e.g., a particular demarcated portion of the user interface or the entire user interface). The one or more data values may then be identified as the one or more data values corresponding to the identified one or more data fields.

After identifying the one or more data values within the first user interface the server 104 may replace, in the first user interface, the one or more data values with one or more substitute values. The one or more substitute values may comprise a text string, numerical string, alphanumerical string, or other value. The one or more substitute values may be at least partially randomly generated. The one or more substitute values may be randomly generated according to a format, regular expression, or other criteria. For example, a substitute value for an IP address data value may be generated according to the format of four randomly generated numbers between 0 and 255 each separated by a period. As another example, a substitute value for a name may comprise two randomly generated strings separated by a space.

The one or more substitute values may also be selected (e.g., randomly) from a pool of potential substitute values. For example, a substitute value for a name data value may be randomly selected from a pool of potential substitute names. The one or more substitute values may also comprise a default substitute value. The one or more substitute values may be determined based on a data type (e.g., a name, an address, a phone number, an IP address, a user ID) of a corresponding data value of the one or more data values. For example, where the substitute value is at least partially randomly generated according to a format, the format may be determined based on the data type of the corresponding data value. As another example, where the substitute value is selected from a pool of potential substitute values or selected as a default substitute value, the pool of potential substitute values or the default substitute value may be determined based on the data type of the corresponding data value.

Replacing the one or more data values with one or more substitute values may comprise sending (e.g., pushed by the server 104 or requested by the user device 102) the one or more substitute values to the user device 102 and causing a refresh or partial refresh of the first user interface. Thus, the one or more substitute values are rendered in the first user interface instead of the identified one or more values.

Next, an image of the first user interface comprising the one or more substitute values is generated. For example, a screenshot or capture of a browser or application comprising the first user interface can be generated (e.g., by the user device 102 and communicated to the server 104). A second user interface may then be provided (e.g., by the server 104) facilitating generating the product enhancement submission. The second user interface may comprise the image of the first user interface. The second user interface may comprise one or more tools or user interface elements that facilitate editing or marking up the image of the first user interface (e.g., adding text, shapes, drawing, cropping, etc.). The second user interface may also comprise one or more text input fields, thereby allowing a user to input a text description of the desired product enhancement. Thus, the product enhancement submission may comprise the text description and/or the image of the first user interface (in modified or unmodified form).

Using this approach, a user may describe a desired product enhancement. The description is enhanced and clarified by the image of the first user interface, thereby allowing the user to provide a clear and understandable submission. As the identified one or more values of the first user interface were automatically replaced with substitute values prior to generating the image, no sensitive or private information is revealed by the image. As this process is automatic, the user does not need to spend time manually redacting sensitive information using obscuring images or shapes. The use of substitute values instead of redaction preserves the readability and design of the first user interface in the submitted product enhancement. The generated image may also be saved by the user device 102 for use in forums, social media, etc., without the risk of disclosing sensitive information and preserving readability of the contents of the first user interface.

After submitting the product enhancement submission via the second user interface, the server 104 may provide the first user interface to the user device 102, thereby returning the user to their place in their original workflow prior to beginning the product enhancement submission. Accordingly, prior to replacing the one or more data values with the one or more substitute values, the one or more data values may be saved (e.g., stored in a cookie, cache, or temporary file on the user device 102 or stored by the server 104). The saved one or more data values may then be included in the first user interface in response to the submission via the second user interface. For example, the server 104 may load the saved one or more data values for inclusion in the provided first user interface. As another example, the user device 102 may automatically populate the first user interface with the stored one or more data values.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1. Additionally, although functionality may be described above as being performed by a server 104, it is understood that this functionality may be performed at least in part by the user device 102.

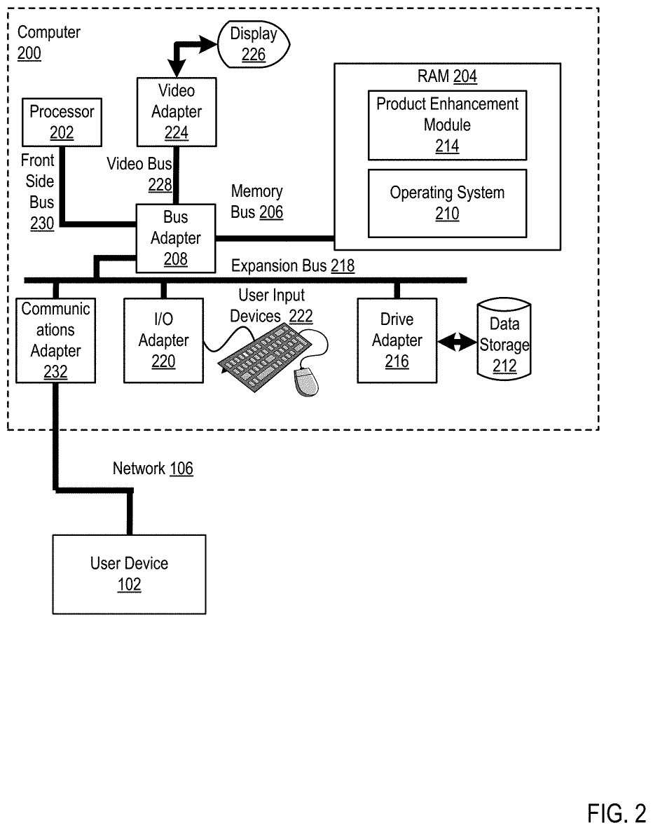

Enhanced usability for product enhancement submissions in accordance with the present invention is generally implemented with computers, that is, with automated computing machinery. For further explanation, therefore, FIG. 2 sets forth a block diagram of automated computing machinery comprising an exemplary computer 200 configured for enhanced usability for product enhancement submissions according to embodiments of the present invention. The computer 200 of FIG. 2 includes at least one computer processor 202 or ‘CPU’ as well as random access memory 204 (RAM′) which is connected through a high speed memory bus 206 and bus adapter 208 to processor 202 and to other components of the computer 200.

Stored in RAM 204 is an operating system 210. Operating systems useful in computers configured for enhanced usability for product enhancement submissions according to embodiments of the present invention include UNIX™, Linux™, Microsoft Windows™, AIX™ IBM's i OS™, and others as will occur to those of skill in the art. The operating system 210 in the example of FIG. 2 is shown in RAM 204, but many components of such software typically are stored in non-volatile memory also, such as, for example, on data storage 212, such as a disk drive. Also stored in RAM is the product enhancement module 214, a module for enhanced usability for product enhancement submissions according to embodiments of the present invention.

The computer 200 of FIG. 2 includes disk drive adapter 216 coupled through expansion bus 218 and bus adapter 208 to processor 202 and other components of the Computer 102. Disk drive adapter 216 connects non-volatile data storage to the computer 200 in the form of data storage 212. Disk drive adapters useful in computers configured for enhanced usability for product enhancement submissions according to embodiments of the present invention include Integrated Drive Electronics (‘IDE’) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer 200 of FIG. 2 includes one or more input/output (‘I/O’) adapters 220. I/O adapters implement user-oriented input/output through, for example, software drivers and computer hardware for controlling output to display devices such as computer display screens, as well as user input from user input devices 222 such as keyboards and mice. The example Computer 102 of FIG. 2 includes a video adapter 224, which is an example of an I/O adapter specially designed for graphic output to a display device 226 such as a display screen or computer monitor. Video adapter 224 is connected to processor 202 through a high speed video bus 228, bus adapter 208, and the front side bus 230, which is also a high speed bus.

The exemplary computer 200 of FIG. 2 includes a communications adapter 232 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for enhanced usability for product enhancement submissions according to embodiments of the present invention include modems for wired dial-up communications, Ethernet (IEEE 802.3) adapters for wired data communications, and 802.11 adapters for wireless data communications.

The communications adapter 232 is communicatively coupled to a network 106 that also includes one or more user devices 102.

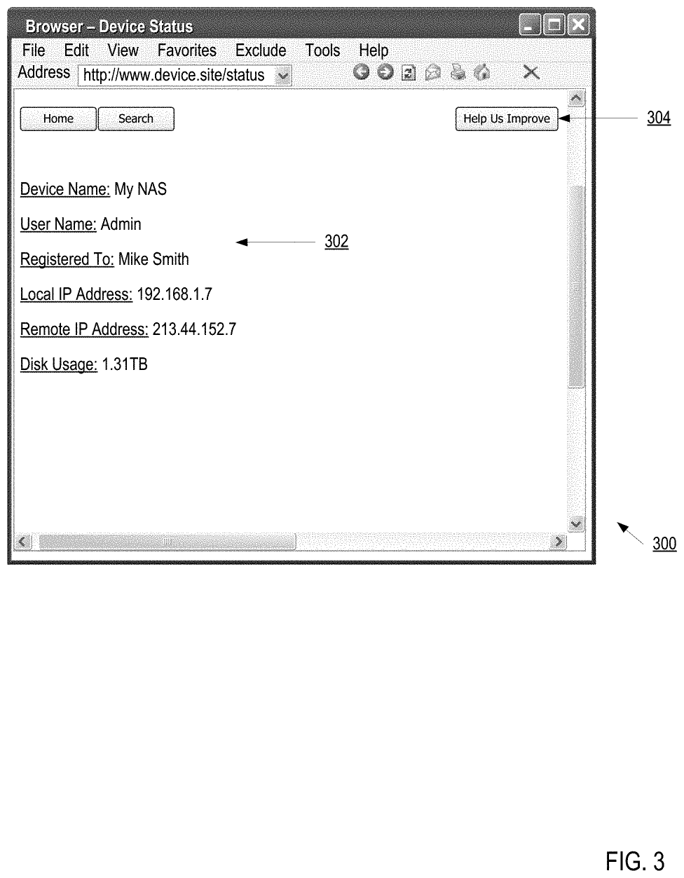

FIG. 3 shows an example user interface 300 for enhanced usability for product enhancement submissions according to embodiments of the present invention. Included in the user interface 300 is an example data table 302 comprising multiple data fields and data values describing the operation of a Network Attached Storage (NAS) device. The example data fields include “Device Name,” “User Name,” “Registered To,” Local IP Address,” “Remote IP Address,” and “Disk Usage,” each having a corresponding data value. A selection of button 304 would cause an indication to the server 104 to generate a product enhancement submission, thereby causing one or more of the data values in the user interface 300 to be replaced with one or more substitute values and further causing an image of the user interface 300 comprising the one or more substitute values to be generated.

FIG. 3 shows an example user interface 400 for enhanced usability for product enhancement submissions according to embodiments of the present invention. The example user interface 400 comprises an image 402, capturing the data table 302 portion of the user interface 300 as seen in FIG. 3. In the image 402, the data values of the user interface 300 have been replaced with one or more substitute values. For example. The data value “Mike Smith” for the “Registered To” data field has been replaced with the substitute value “John Doe.” As another example, the “213.44.152.7” data value for the “Remote IP Address” data field has been replaced with the substitute value “255.255.255.255.” The user interface 400 also comprises tools 404 for editing or marking the image 402, as well as a text input 406 for describing the desired product enhancement. The user interface 400 further includes a button 408 that causes the image 402 to be saved (e.g., in its original or modified state) to the user device 102. Button 410 causes a product enhancement submission comprising the image 402 and any input to the text input 406 to be submitted to the server 104. Selecting the button 410 may also cause the user device 102 to return to the first user interface (e.g., the user interface 300).

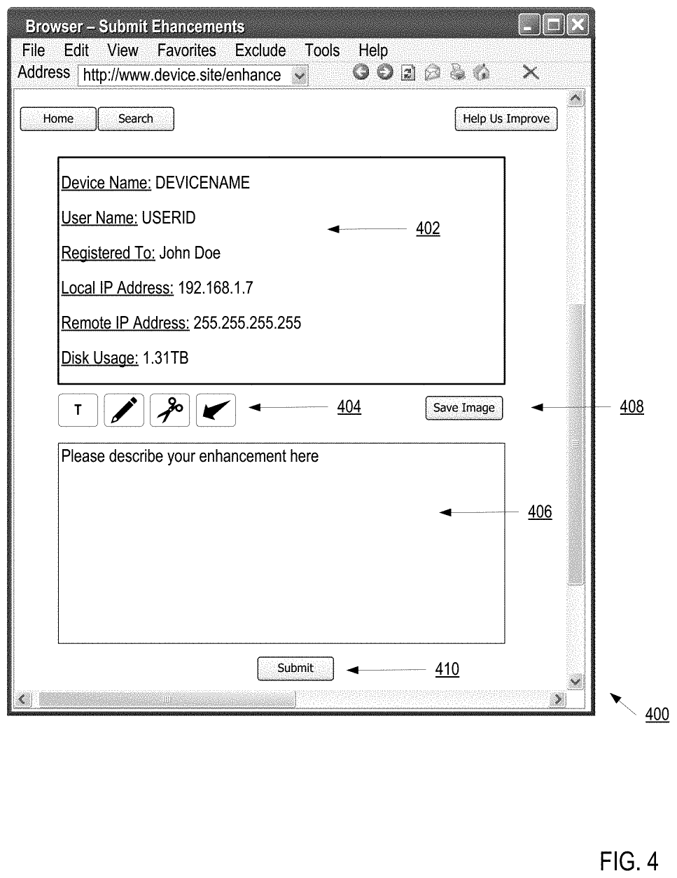

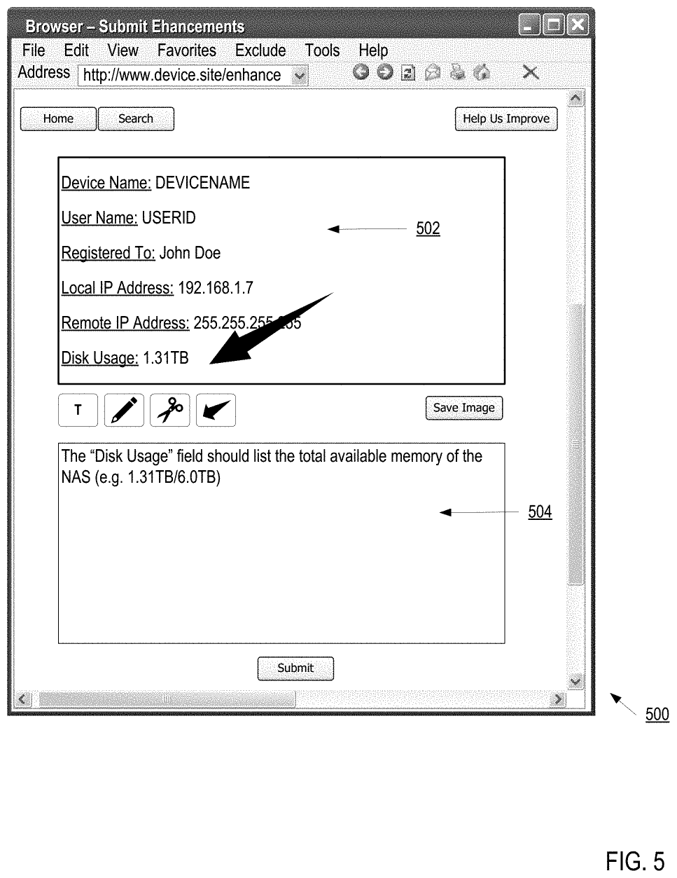

FIG. 5 shows an example user interface 500 for enhanced usability for product enhancement submissions according to embodiments of the present invention. Included in the user interface 500 is an image 502. The image 502 is a marked version of the image 402 of FIG. 4, with an arrow added in to direct attention to a particular portion of the depicted user interface. A text description 504 has been input to the text input 406 of FIG. 4 describing the feature that the user wishes to be added.

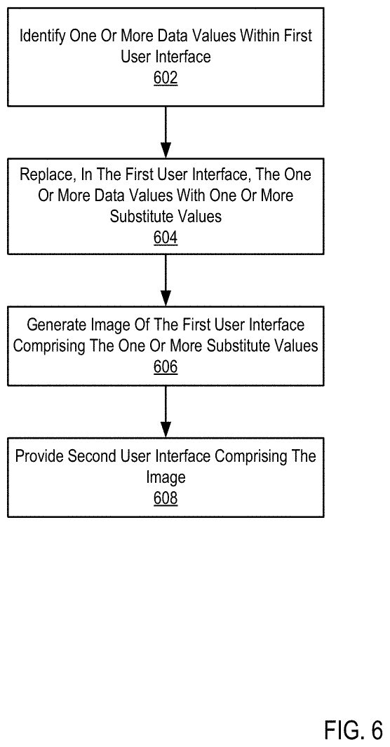

For further explanation, FIG. 6 sets forth a flow chart illustrating an exemplary method for enhanced usability for product enhancement submissions according to embodiments of the present invention that includes identifying 602 (e.g., by a server 104), in response to an indication to generate a product enhancement submission associated with a first user interface, one or more data values within the first user interface. The one or more data values may comprise one or more data values that a user may wish to obfuscate or conceal from a third party (e.g., a product developer, another user, etc.). For example, the one or more data values may include a user ID, contact information including a real name, address, phone number, or email address, network identifiers including Internet Protocol (IP) addresses, Media Access Control (MAC) addresses, hardware or device configuration information, etc.

Identifying the one or more data values within the first user interface may comprise identifying, from a plurality of data fields within the first user interface, one or more data fields comprising an identifier. Identifying the one or more data values within the first user interface may also comprise identifying each data field or data value within a particular template element or user interface element (e.g., a particular demarcated portion of the user interface or the entire user interface). The one or more data values may then be identified as the one or more data values corresponding to the identified one or more data fields.

The method of FIG. 6 may further comprise replacing 604 (e.g., by the server 104, by the user device 102), in the first user interface, the one or more data values with one or more substitute values. The one or more substitute values may comprise a text string, numerical string, alphanumerical string, or other value. The one or more substitute values may be at least partially randomly generated. The one or more substitute values may be randomly generated according to a format, regular expression, or other criteria. For example, a substitute value for an IP address data value may be generated according to the format of four randomly generated numbers between 0 and 255 each separated by a period. As another example, a substitute value for a name may comprise two randomly generated strings separated by a space.

The one or more substitute values may also be selected (e.g., randomly) from a pool of potential substitute values. For example, a substitute value for a name data value may be randomly selected from a pool of potential substitute names. The one or more substitute values may also comprise a default substitute value. The one or more substitute values may be determined based on a data type (e.g., a name, an address, a phone number, an IP address, a user ID) of a corresponding data value of the one or more data values. For example, where the substitute value is at least partially randomly generated according to a format, the format may be determined based on the data type of the corresponding data value. As another example, where the substitute value is selected from a pool of potential substitute values or selected as a default substitute value, the pool of potential substitute values or the default substitute value may be determined based on the data type of the corresponding data value.

Replacing the one or more data values with one or more substitute values may comprise sending (e.g., pushed by the server 104 or requested by the user device 102) the one or more substitute values to the user device 102 and causing a refresh or partial refresh of the first user interface. Thus, the one or more substitute values are rendered in the first user interface instead of the identified one or more values.

The method of FIG. 6 may further comprise generating 606 (e.g., by the server 104, by the user device 102), an image of the first user interface comprising the one or more substitute values. For example, a screenshot or capture of a browser or application comprising the first user interface can be generated (e.g., by the user device 102 and communicated to the server 104).

The method of FIG. 6 may further comprise providing 608 (e.g., by the server 104) a second user interface facilitating generating the product enhancement submission, wherein the second user interface comprises the image of the first user interface. The second user interface may comprise the image of the first user interface. The second user interface may comprise one or more tools or user interface elements that facilitate editing or marking up the image of the first user interface (e.g., adding text, shapes, drawing, cropping, etc.). The second user interface may also comprise one or more text input fields, thereby allowing a user to input a text description of the desired product enhancement. Thus, the product enhancement submission may comprise the text description and/or the image of the first user interface (in modified or unmodified form).

Using this approach, a user may describe a desired product enhancement. The description is enhanced and clarified by the image of the first user interface, thereby allowing the user to provide a clear and understandable submission. As the identified one or more values of the first user interface were automatically replaced with substitute values prior to generating the image, no sensitive or private information is revealed by the image. As this process is automatic, the user does not need to spend time manually redacting sensitive information using obscuring images or shapes. The use of substitute values instead of redaction preserves the readability and design of the first user interface in the submitted product enhancement. The generated image may also be saved by the user device 102 for use in forums, social media, etc., without the risk of disclosing sensitive information and preserving readability of the contents of the first user interface.

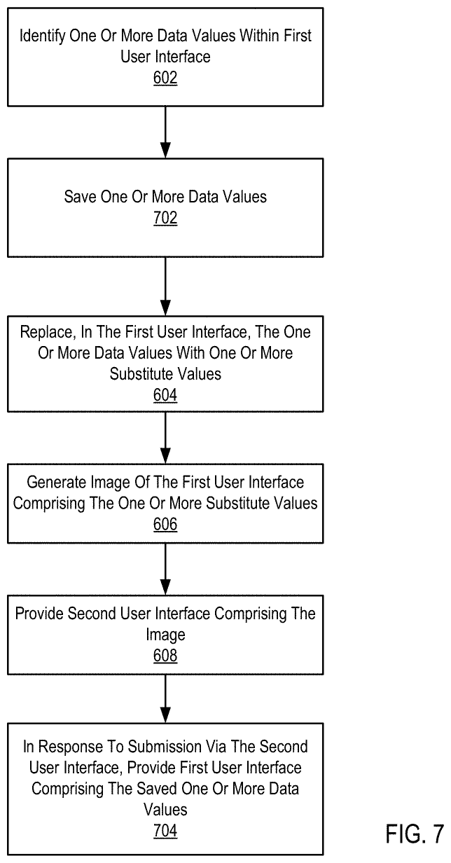

For further explanation, FIG. 7 sets forth a flow chart illustrating an exemplary method for enhanced usability for product enhancement submissions according to embodiments of the present invention that includes identifying 602, in response to an indication to generate a product enhancement submission associated with a first user interface, one or more data values within the first user interface, replacing 604, in the first user interface, the one or more data values with one or more substitute values, generating 606 an image of the first user interface comprising the one or more substitute values, and providing 608 a second user interface facilitating generating the product enhancement submission, wherein the second user interface comprises the image of the first user interface.

FIG. 7 differs from FIG. 6 in that the method of FIG. 7 further comprises saving 702 (e.g., by the server 104, by the user device 102) the identified one or more data values. For example, prior to replacing the one or more data values with the one or more substitute values, the one or more data values may be saved (e.g., stored in a cookie, cache, or temporary file on the user device 102 or stored by the server 104). FIG. 6 further differs from FIG. 6 in that the method of FIG. 7 further comprises providing 704 (e.g., by the server 104), the first user interface comprising the saved one or more data values. For example, the server 104 may load the saved one or more data values for inclusion in the provided first user interface. As another example, the user device 102 may automatically populate the first user interface with the stored one or more data values.

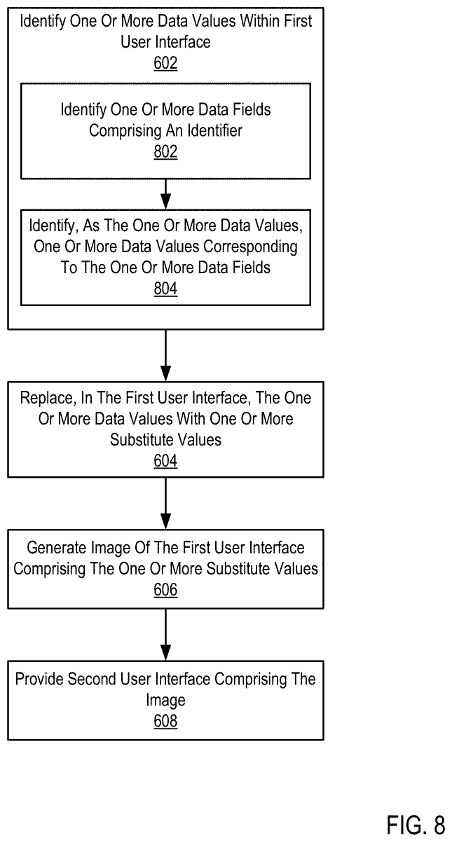

For further explanation, FIG. 8 sets forth a flow chart illustrating an exemplary method for enhanced usability for product enhancement submissions according to embodiments of the present invention that includes identifying 602, in response to an indication to generate a product enhancement submission associated with a first user interface, one or more data values within the first user interface, replacing 604, in the first user interface, the one or more data values with one or more substitute values, generating 606 an image of the first user interface comprising the one or more substitute values, and providing 608 a second user interface facilitating generating the product enhancement submission, wherein the second user interface comprises the image of the first user interface.

FIG. 8 differs from FIG. 6 in that identifying 602 the one or more data values within the first user interface comprises identifying 804, from a plurality of data fields within the first user interface, one or more data fields comprising an identifier. The plurality of data fields may comprise input fields for a user to input a particular data value. The plurality of data fields may also comprise fields for displaying data values communicated by the server 104. For example, the user interface may be encoded using a markup language or other layout encoding that allows for tags, codes, or other identifiers to be associated with data fields. Accordingly, identifying the one or more data fields comprising the identifier may comprise identifying, from the plurality of data fields, the one or more data fields associated with a tag, code, or identifier indicating that a corresponding data value should be obfuscated in the product enhancement submission. FIG. 8 differs from FIG. 6 in that identifying 602 the one or more data values within the first user interface comprises identifying 802 as the one or more data values, one or more values corresponding to the identified one or more data fields.

In view of the explanations set forth above, readers will recognize that the benefits of enhanced usability for product enhancement submissions according to embodiments of the present invention include:
User interfaces are automatically modified to include substitute values prior to automatically generating an image of the user interface, preventing the inclusion of potentially sensitive information in product enhancement submissions.
Automatically modifying user interfaces to include substitute values prior to automatically generating an image of the user interface eliminates the need for manual redaction of information and preserves readability that would be reduced by redaction markings.

Exemplary embodiments of the present invention are described largely in the context of a fully functional computer system for enhanced usability for product enhancement submissions. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of enhanced usability for product enhancement submissions, the method comprising:
identifying, in response to an indication to generate a product enhancement submission associated with a first user interface, one or more data values within the first user interface;
replacing, in the first user interface, the one or more data values with one or more substitute values;
generating an image of the first user interface comprising the one or more substitute values; and
providing a second user interface facilitating generating the product enhancement submission, wherein the second user interface comprises the image of the first user interface.

2. The method of claim 1, wherein the second user interface facilitates an editing of the image of the first user interface.

3. The method of claim 1, wherein the second user interface comprises a text input field associated with the product enhancement submission.

4. The method of claim 1, further comprising:
saving the one or more data values of the first user interface; and
in response to a submission via the second user interface, providing the first user interface comprising the saved one or more data values.

5. The method of claim 1, wherein identifying the one or more data values comprises:
identifying, from a plurality of data fields, one or more data fields comprising an identifier; and
identifying, as the one or more data values, one or more data values corresponding to the one or more data fields.

6. The method of claim 1, wherein the one or more substitute values are randomly generated.

7. The method of claim 1, wherein the one or more substitute values are each determined based on a data type of a corresponding data value of the one or more data values.

8. An apparatus for enhanced usability for product enhancement submissions, the apparatus comprising a computer processor, a computer memory operatively coupled to the computer processor, the computer memory having disposed within it computer program instructions that, when executed by the computer processor, cause the apparatus to carry out the steps of:
identifying, in response to an indication to generate a product enhancement submission associated with a first user interface, one or more data values within the first user interface;
replacing, in the first user interface, the one or more data values with one or more substitute values;
generating an image of the first user interface comprising the one or more substitute values; and
providing a second user interface facilitating generating the product enhancement submission, wherein the second user interface comprises the image of the first user interface.

9. The apparatus of claim 8, wherein the second user interface facilitates an editing of the image of the first user interface.

10. The apparatus of claim 8, wherein the second user interface comprises a text input field associated with the product enhancement submission.

11. The apparatus of claim 8, wherein the steps further comprise:
saving the one or more data values of the first user interface; and
in response to a submission via the second user interface, providing the first user interface comprising the saved one or more data values.

12. The apparatus of claim 8, wherein identifying the one or more data values comprises:
identifying, from a plurality of data fields, one or more data fields comprising an identifier; and
identifying, as the one or more data values, one or more data values corresponding to the one or more data fields.

13. The apparatus of claim 8, wherein the one or more substitute values are randomly generated.

14. The apparatus of claim 8, wherein the one or more substitute values are each determined based on a data type of a corresponding data value of the one or more data values.

15. A computer program product for enhanced usability for product enhancement submissions, the computer program product disposed upon a non-volatile computer readable medium, the computer program product comprising computer program instructions that, when executed, cause a computer to perform steps comprising:
identifying, in response to an indication to generate a product enhancement submission associated with a first user interface, one or more data values within the first user interface;
replacing, in the first user interface, the one or more data values with one or more substitute values;
generating an image of the first user interface comprising the one or more substitute values; and
providing a second user interface facilitating generating the product enhancement submission, wherein the second user interface comprises the image of the first user interface.

16. The computer program product of claim 15, wherein the second user interface facilitates an editing of the image of the first user interface.

17. The computer program product of claim 15, wherein the second user interface comprises a text input field associated with the product enhancement submission.

18. The computer program product of claim 15, wherein the steps further comprise:
saving the one or more data values of the first user interface; and
in response to a submission via the second user interface, providing the first user interface comprising the saved one or more data values.

19. The computer program product of claim 15, wherein identifying the one or more data values comprises:
identifying, from a plurality of data fields, one or more data fields comprising an identifier; and
identifying, as the one or more data values, one or more data values corresponding to the one or more data fields.

20. The computer program product of claim 15, wherein the one or more substitute values are randomly generated.
